(19) United States
(12) Patent Application Publication
(10) Pub. No.: US 2004/0212696 A1
(43) Pub. Date: Oct. 28, 2004

(54) Digital camera with adjustment of color image signal and an imaging control method therefor

(75) Inventors: Makoto Tsugita, Asaka-shi (JP); Takeshi Miyashita, Asaka-shi (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 10/824,562

(22) Filed: Apr. 15, 2004

(30) Foreign Application Priority Data
Apr. 22, 2003 (JP) 2003-116900

(51) Int. Cl. H04N 5/262

(52) U.S. Cl. 348/231.6

(57) ABSTRACT

A digital camera and an imaging control method in which manual white balance adjustment and shading correction may be achieved simultaneously to enable a photographed image to be produced to a high accuracy. When the operating information commanding manual white balance adjustment is entered with an operating unit, the condition for shading correction and white balance adjustment of the image signal is formulated by a system controller and stored in a memory during calibration imaging. The image signal data produced by actual imaging are subjected by a digital signal processor to shading correction and white balance adjustment in accordance with the formulated correction condition.

### BACKGROUND OF THE INVENTION

1. Field of the Invention

The present invention relates to a digital camera in which a color image signal captured by an image pickup device is adjusted in white balance, and an imaging control method therefor.

2. Description of the Background Art

A variety of correction functions are loaded on recently marketed digital cameras. Typical of the correction functions is the function of the white balance adjustment for adjusting the white balance in keeping with a light source used at the time of imaging and, in a large number of cameras, the white balance is corrected automatically. In certain high function digital cameras, a manual white balance adjustment function is loaded for enabling fine white balance adjustment in keeping with a light source. For example, in Japanese Patent Laid-Open Publication 127451/1999, there is disclosed a white balance adjustment device employing a manual white balance adjustment system for selecting the sort of the light source by a manual operation. The manual white balance adjustment is calibrated with a larger size of white or gray paper sheet placed in front of a camera set for imaging.

In the digital camera, a variety of correction functions are loaded as the functions other than the function of white balance adjustment. As one of the functions, there is a function which corrects the shading in which the peripheral portions of a photographed image are darker. As with manual white balance adjustment, the shading correction may be calibrated with an achromatic paper sheet, for example, placed in front of a camera lens, or by photographing a wall surface of, for example, a studio. An electronic still camera, in which a processing procedure of sequence for adjusting the white balance or correcting the shading is stored in a memory, and in which reproducing processing is carried out optimum to a monitor display, is disclosed in, for example, U.S. Pat. No. 6,650,365.

The shading of cameras are usually corrected by a manufacturer, when manufactured prior to shipment, to such an extent that there is presented no practical inconvenience. However, in actual imaging, the shading may be changed depending on various imaging conditions, such as a stop number or a zooming position at the time of imaging. Thus, for achieving more stringent adjustment, it is after all desirable that adjustment shall be carried out under an actual imaging condition. In the Japanese Patent Laid-Open Publication 2000-41179, there is disclosed an image input apparatus in which shading correction data associated with plural conditions of an optical system are recorded on a ROM (Read-Only Memory) or a RAM (Random Access Memory) and the image signal is corrected with the selected correction data.

However, the white balance adjustment and the shading correction need to be carried out separately, thus necessitating a complicated operation. There is also presented a problem that, if the stop number is changed at the time of imaging, the shading state is then changed, so that the sequence of shading correction operation need to be carried out again each time the stop number is changed.

### SUMMARY OF THE INVENTION

It is an object of the present invention to provide a digital camera, in which, under a stringent image-pickup condition in which the white balance (WB) has to be set manually (by manual operation), the manual white balance adjustment and the manual shading correction can be carried out simultaneously to enable an image to be photographed to a high accuracy. It is also an object of the invention to provide a method for controlling the imaging in such a digital camera.

The present invention provides a digital camera for photo-electrically transducing an object field formed by an image pick-up lens into an image signal representing the object field, which digital camera comprises an image sensor for generating an image signal representing the image of the object field formed, a signal processor for processing the image signal to produce image data, an outputting circuit for outputting the image data produced, a controller responsive to operating information for controlling the image sensor, the signal processor and the output circuit for generating a shading correction condition and a white balance adjustment condition for correcting the image signal, a storage for storing the adjustment and correction conditions, and an operating unit for receiving the operating information corresponding to an operation by an operator. Upon recognition that the operating information commands the manual white balance adjustment, the controller controls calibration imaging for imaging an object placed in front of the image pick-up lens, generates the shading correction condition and the white balance adjustment condition for correcting the image signal generated at the time of actual imaging, based on the image signal generated by the image sensor at the time of calibration imaging, and causes the generated adjustment and correction conditions to be stored in the storage. When commanding the actual imaging to cause the generated image signal to be processed by the signal processor, the controller reads out the shading correction condition and the white balance adjustment condition stored in the storage to send out the read-out adjustment and correction conditions to the signal processor. The signal processor corrects the shading of the image signal for the actual imaging in accordance with the shading condition supplied from the controller, and also corrects the white balance of the image signal for the actual imaging in accordance with the white balance adjustment condition supplied from the controller.

In the calibration imaging, the controller may generate the shading correction condition associated with a plurality of stop numbers to cause the generated correction condition to be stored in the storage. The controller may read out the shading correction condition associated with one of the stop numbers which was used in the actual imaging from the storage to send out the read-out correction condition to the signal processor.

In the calibration imaging, the controller may generate the white balance adjustment condition associated with a plurality of stop numbers to cause the generated correction condition to be stored in the storage. The controller may also read out the white balance adjustment condition associated with one of the stop numbers which was used at the time of the actual imaging from the storage to send out the read-out correction condition to the signal processor.

The present invention also provides a method of controlling imaging with an image sensor photo-electrically transducing an optical image formed on the image sensor through an imaging lens to generate an image signal, which method comprises a step of recognizing operating information commanding manual white balance adjustment, a calibration imaging step of imaging an object for use in calibrating the manual white balance adjustment, a correction condition generating step of generating a shading correction condition for correcting shading of an image signal generated in actual imaging, and a white balance adjustment condition for adjusting white balance of the image signal generated in the actual imaging, based on the image signal generated by the calibration imaging step, an actual imaging step of controlling the actual imaging responsive to operating information corresponding to an operation by an operator, and a signal processing step of processing the image signal generated by the actual imaging step, and correcting the shading of the image signal generated by the actual imaging step, based on the shading correction condition and the white balance adjustment condition.

In this case, the calibration imaging step may generate the shading correction condition associated with a plurality of stop numbers. The signal processing step may correct the image signal based on the shading correction condition associated with one of the stop numbers which was used in the actual imaging step.

The calibration imaging step may generate the white balance adjustment condition associated with a plurality of stop numbers. The signal processing step corrects the image signals based on the white balance adjustment condition associated with one of the stop numbers which was used in the actual imaging step.

According to the present invention, shading correction may automatically be carried out in conjunction with white balance adjustment when manual white balance adjustment is to be carried out for manually setting the white balance under e.g. a stringent imaging condition, thus achieving a photographed image to high precision.

Moreover, since the correction condition associated with a plurality of stop values may be formed and stored at the time of calibration imaging, change of the stop value on the occasion of actual imaging can be flexibly coped with without re-formulating the correction condition. Hence, an optimum photographed image may be obtained at the time of the manual adjustment.

In addition, the correction condition may be formulated and stored, so that, even when high accuracy is demanded in the stringent correction processing, or when e.g. an imaging lens is exchanged, image signal data may be accurately corrected and adjusted under a variable imaging condition such as a change of the iris stop used for imaging.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram of a digital camera embodying the present invention;

FIG. 2 shows an example of a correction table prepared for a white balance adjusting and shading correcting condition associated for iris stop F-numbers;

FIG. 3 is a graph plotting the level of a luminance signal against a pixel position in the horizontal scanning direction obtained by imaging for calibration;

FIG. 4 is a graph exemplarily plotting a shading correction signal of the characteristics canceling the shading of the luminance signal shown in FIG. 3;

FIG. 5 is a graph exemplarily plotting the output level of a luminance signal resultant from applying the shading correction condition to the luminance signal and synthesizing the latter;

FIG. 6 is a flowchart useful for understanding the operation in preparing a correction condition when manually adjusting white balance of the digital camera;

FIG. 7 is a flowchart useful for understanding the operation for correcting the shading and adjusting the white balance in the correction condition for actual imaging when the digital camera is in the manual white balance adjustment mode; and

FIG. 8 is a flowchart useful for understanding another operational example of preparing the correction condition for manual white balance adjustment for the digital camera.

### DESCRIPTION OF THE PREFERRED EMBODIMENTS

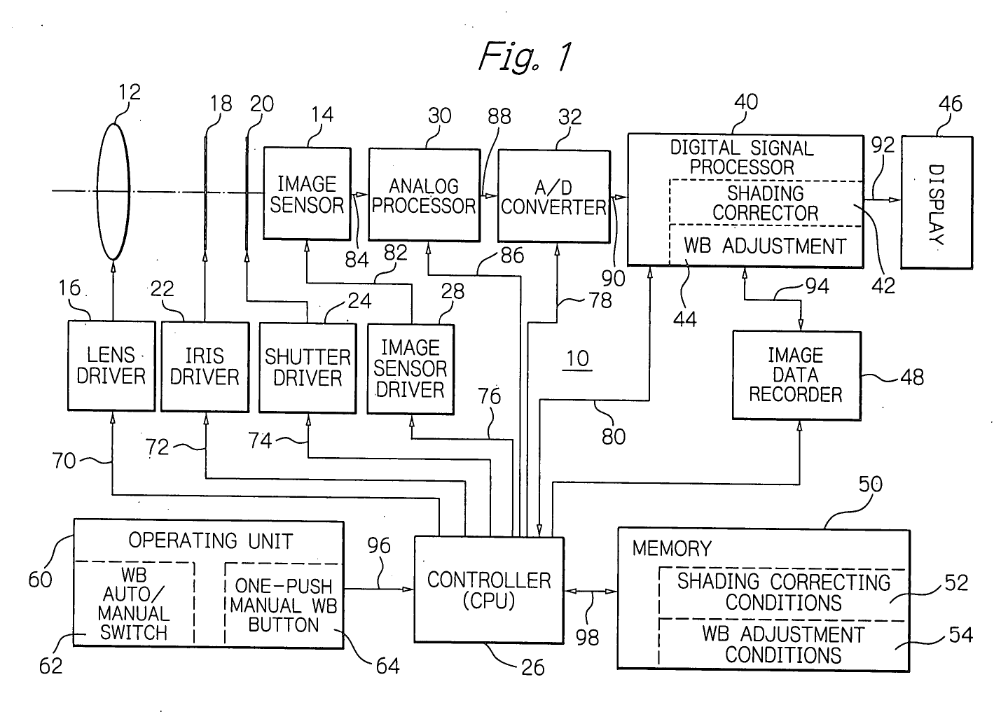

With reference to FIG. 1, a digital camera according to the present invention will be described in detail. FIG. 1 shows an embodiment of a digital camera of the present invention. The digital camera 10 of the present embodiment includes an imaging device or image sensor 14 for generating an image signal 84 representative of an optical image formed by an imaging lens 12. The digital camera 10 is adapted to process the image signal 84 and display a picture represented by the signal on a monitor screen, while recording the processed image data on an information recording medium.

As the image pick-up lens 12, a zoom lens with a variable focal length is used. The digital camera 10 includes, in addition to the image pick-up lens 12, an iris stop 18, a mechanical shutter 20, a lens driving unit or driver 16 for adjusting the focus position and focal length of the image pick-up lens 12, an iris driver 22 for driving the iris stop 18, a shutter driver 24 for driving the mechanical shutter 20, and an image sensor driver 28 for driving the image sensor 14. The lens driver 16, iris driver 22, shutter driver 24 and image sensor driver 28 are controlled responsive to control signals 70, 72, 74 and 76 supplied from a system controller 26, respectively. The image pick-up lens 12 maybe of a type of interchangeable lens detachably mounted on the digital camera 10. In the latter case, the lens driver 16, iris stop 18 and iris driver 22 may preferably be included in the image pick-up lens or optics 12.

The mechanical shutter 20 is driven to its open state during photographing movie pictures, whereas being driven to close its slit at the end of light exposure during photographing a still image. The mechanical shutter 20 is able to give an extensive range of light exposure time, that is, a shutter speed, in conjunction with the electronic shutter control for electrically driving the imaging device 14.

The imaging device 14 is adapted for capturing an optical image formed thereon through the lens 12 from an object field to be photographed. The imaging device 14 is a two-dimensional image sensor having a plural number of photosensitive sells, not shown, arrayed to be shifted from each other by one-half of the pitch thereof in the horizontal scanning direction (H) and in the vertical scanning direction (V). The image sensor 14 further includes a plurality of vertical charge transfer channels arranged in a zigzag pattern in the inter-cell space in the vertical scanning direction and adapted for transferring signal charges generated in the associated photosensitive cells in the vertical scanning direction, and a horizontal charge transfer channel for transferring signal charges from the vertical charge transfer channels in the horizontal scanning direction, although not specifically shown. The image sensor 12 includes an output amplifier, not shown, for detecting and amplifying the signal charges thus transferred to output the signal charges in the form of electrical signal, and a plural number of micro-lenses each arranged on associated one of the photosensitive cells and being a convex lens for concentrating the impinging beam onto the associated cell.

With the present embodiment, the vertical charge transfer channels and the horizontal charge transfer channel are of the charge-coupled device (CCD) type. To the imaging device 14, a MOS type of image sensor may also be applicable. The photosensitive cells, i.e. plural pixels, are formed by photodiodes generating signal charges, which are in turn transferred responsive to shift pulses through transfer gates arranged between the photodiodes and the vertical charge transfer channels to the vertical charge transfer channels.

In the image sensor 14, a layer between the micro-lens and the photosensitive cells includes an on-chip color filter, not shown, having filter segments arranged of the three primary colors or the complementary colors in a certain array pattern. As the arraying pattern of the color filter, a green (G)-stripe red (R)/blue (B) complete checkerboard pattern, for example, is advantageously used for the primary color filter. The imaging device 14 in the present embodiment is of the honeycomb type of pixel array and vertical transfer channels. The vertical charge transfer channels are of a zigzag pattern. The imaging device 14 is, however, not limited to this specific type but may for example be formed by an array of photosensitive cells of a rectangular shape arranged in the vertical and horizontal stripes in the form of lattice. With the photosensitive cells provided with the above-stated color filter, the pixel values of R, G and B in the respective pixel positions are calculated by processing operation, as will later be described, to generate a color picture signal.

The present digital camera 10 is a solid-state imaging device for using the image signal 84 obtained from the respective photosensitive cells to generate a signal representative of movie pictures or a still picture and output a signal for displaying or archiving the pictures responsive to the movie and still image signals. The micro-lenses, adapted for collecting the incident light on the photosensitive array of the imaging device 14, are on-chip micro-lenses deposited on the upper or front surface of the respective color filters provided on the photosensitive cells. For example, as many as from hundreds of thousands to millions of effective pixels are formed in the photosensitive array. Since the image pick-up lens 12 has a zooming function of variable focal length, the exit pupil position is dependent rather drastically upon the focal length ranging from its short to long focal length, thus causing the shading effect also dependent upon the focal length. Moreover, since the exit pupil position is changed appreciably with the opening diameter of the iris stop (F-number), the shading effect is also dependent upon the stop number.

The peripheral part of the photosensitive array of the imaging device 14 far from the center of the array corresponding to the optical axis of the image pick-up lens 12 receives the light incident in the oblique direction from the image pick-up lens 12 more than the light incident into the central part of the array. Hence, on the photosensitive array, blur circles are formed by the incident light to be shifted depending on the pixel positions, due to for example the distance between the micro-lens layer and the photodiode layer, so that the volume of received light is dependent upon the pixel position. The shading is also caused by the light incident in the oblique direction due to the three-dimensional structure of the photodiodes.

In the instant embodiment, when imaging for calibration of manual white balance adjustment, a white or gray paperboard is placed in front of the camera lens 12. A plurality of frames are shot corresponding to the number of stages of stop values to produce and store in a memory, not shown, the conditions of manual white balance adjustment and shading correction, which will be used on a color image signal obtained on an actual image-pickup operation. With the manual white balance adjustment mode selected, when the actual imaging operation is carried out, the image signal data are corrected in shading in accordance with shading correction condition, stored in the memory, while being adjusted in white balance in accordance with white balance adjustment condition, also stored in the memory.

Meanwhile, the camera 10 also has the functions of automatically adjusting the white balance and correcting the shading on an image signal. The above-described manual white balance adjustment causes an image of higher quality to be photographed in a photographing environment of precision to the extent that the photographer requires the white balance to be adjusted by the manual calibration, in terms of correcting the shading more accurately in dependent upon the photographing environment in addition to the manual white balance adjustment in accordance with the correction conditions manually calibrated.

The drive signal 82 for driving the imaging device 14, such as horizontal and vertical transfer pulses, is supplied from the image sensor driver 28 to the imaging device 14. The image sensor driver 28 is responsive to the timing signal 76 generated by a timing generator, not shown, provided in the system controller 26, to generate the drive signal 82 used for driving the imaging device 14. The image sensor driver 28 sends out the drive signal 82, differing depending on whether the prevailing mode is the movie or still picture mode, to the imaging device 14. The timing generator is adapted to generate the drive signal 82 including various timing signals, such as a vertical drive timing signal, a horizontal drive timing signal, transfer gate pulses or pixel clocks. The controller 26, including a central processor unit (CPU), not shown, supplies the lens driver 16, the iris driver 22, the shutter driver 24, the image sensor driver 28, an analog processor 30, an analog-to-digital (A/D) converter 32 and a digital-signal processor 40 with the generated timing signals 70, 72, 74 and 76 and control signals 78 and 80, respectively.

In the movie mode, the image sensor driver 28 generates the drive signal 82, which is used for shifting signal charges of the respective photosensitive cells, or every predetermined number of photosensitive cells with decimation or thinning, in the vertical scanning direction, into the associated vertical charge transfer channels on a pixel-by-pixel basis to form a horizontal readout line, and mixing the signal charges of the thus read-out plural pixels, i.e. pixel data, between the readout lines with each other along the vertical transfer channels to transfer the mixed signal charges in the vertical scanning direction. During the vertical synchronization period (VD), shift pulses are applied to the transfer electrodes of the imaging device 14 to read out signal charges generated in the photodiodes. After the vertical synchronization period (VD), the vertical transfer pulses are supplied to the associated transfer electrodes to read out the pixels of the readout lines selected at intervals, that is, every selected number of lines.

During the still picture mode, the image sensor driver 28 generates the drive signal 82 for reading out pixels every other line in the first and second fields, with embodiment. The pixels read out separately in the first and second field are interpolated in the subsequent digital signal processing to generate respective pixel values of the three prime colors R, G and B to thereby establish the color pixel values at the respective pixel positions.

The imaging device 14 has its output 84 connected to the analog processor 30. The analog processor 30 includes a correlated double sampling (CDS) circuit, not shown, for removing the reset noise contained in the input image signal 84, and a gain-controlled amplifier (GCA), also not shown, for amplifying the level of the image signal with its controllable gain. The analog processor 30 is enabled in synchronism with the timing signal 82 generated by the image sensor driver 28. The gain-controlled amplifier is adapted for amplifying the image signal with a gain which is in keeping with a control signal 86 supplied from the controller 26. The analog processor 30 has its output 88 connected to the analog-to-digital converter 32. The A/D converter 32 is adapted to convert the input image signal 88 to e.g. a 12-bit digital value, which will in turn on its output 90.

The digital signal processor 40, connected to the output 88 of the A/D converter 32, is adapted for processing and storing the digitized image signal data 90 under the control of the controller 26 to produce image data 92 and 94 for display and recording, respectively. The digital signal processor 40 outputs the thus produced image data 92 for display to a display unit 46, while outputting the image data 94 for recording. The digital signal processor 40 will be described subsequently in detail.

The display unit 46 includes a liquid crystal display screen, not shown, adapted for displaying thereon an image represented by the image data 92 for display, which are received from the digital signal processor 40 and represent a photographed or reproduced image. The display unit 46 may also have the function of producing and outputting an image signal for display on an exterior display unit, not specifically shown.

The camera 10 also includes an image data recorder or image data recording unit 48, which is responsive to the controller 26 to output and readably recording compressed or non-compressed, encoded image data to an information recording medium, not shown, mounted thereon. The image data recorder 48 is adapted to record an image file, prepared with various imaging information appended to image data, into a directory structured in hierarchy of a predetermined format with a filename added different from one image file to another. The information recording medium may, for example, be a memory card having for example a semiconductor storage device or a large capacity information recording (mass storage) medium, such as a rewritable optical or magnetic disc. The image data recorder 48 may also be provided with the function of transmitting an image file prepared to another information processor interconnected thereto by wired or wireless connection.

The system controller 26, preferably implemented by a CPU as stated above, includes the system controlling function of generating the timing and control signals for controlling the entire operation of the digital camera 10, responsive to operation information 96 sensed by an operating unit or control panel 60, to send out the so-generated signals to various components. The controller 26 also includes the function of generating the control information for controlling imaging operation based on the picture data processed by the digital signal processor 40, and is responsive to the operating information 96 sensed by the operating unit 60 to set the digital camera 10 to the still picture or movie mode to control the associated components of the camera 10. The controller 26 is made up by a computer system including a CPU, a ROM, a RAM, a reference clock generator and input/output circuits, not specifically illustrated. The ROM has a control program sequence stored therein. The controller 26 performs various processing operations in response to the program sequence and the operating information 96 entered on the operating unit 64.

Specifically, the system control 26 controls the focusing of the image pickup lens 12, while adjusting the zooming angle. In addition, the controller 26 detects and memorizes the current focusing and zooming positions of the imaging lens 12. In the present embodiment, when the first stroke to the shutter release switch, not shown, accommodated in the operating unit 60, is detected, the controller 26 sets the movie mode, whereas if the second stroke is detected, the controller 26 sets the still picture mode. The focal and zooming positions of the image pick-up lens 12 may be adjusted manually, instead of being automatically controlled by the controller 26. In such a case also, the controller 26 determines the focal and zooming positions of the image pick-up lens 12.

In the movie mode, the controller 26 generates the drive signal 76 for driving the imaging device 14 in the decimated readout mode to send out the thus generated control signal 76 toward the image sensor driver 28. Moreover, in the still picture mode, the controller 26 generates the control signal 76 for commanding the whole-pixel readout driving for reading out all pixels from the imaging device 14 with two fields to send out the so-generated signal 76 to the image sensor driver 28.

The controller 26 has the function of storage control for an image memory 50 to produce an address signal representing an address of a storage location for image signal data and read and write signals controlling the read and write of image signal data to send the so-produced signal 98 to the image memory 50.

The controller 26 also has the function of producing the correction information for the white balance adjustment and shading correction conditions to store the produced information in the image memory 50 together with the associated stop number (F-number). Specifically, in order to reduce the shading changeable in dependent upon the image pickup condition such as the nature of a light source in an object field or the stop number used when imaging, the controller 26 has such a function that, when a white balance auto/manual switch 62 provided on the operating unit 60 is set to its manual side, and a depression of a one-push manual white balance button 64 also provided on the operating unit 60 is detected, the controller 26 causes the condition-finding or calibrating image pickup operation to be started to produce a correction condition for manual white balance adjustment so as to perform white balance adjustment and shading correction in keeping with the correction condition at the time of actual image pickup operation with manual adjustment.

In this case, the controller 26 produces, in performing manual white balance adjustment, the shading correction and white balance adjustment conditions, based on image signal data obtained on performing the condition-finding or calibrating image pickup operation for the purpose of manual white balance adjustment, to cause the so-produced conditions to be stored in the memory 50. Moreover, in correcting the image data at the time of actual image pickup operation, the controller 26 forwards the control signal 98 including the shading correcting condition stored in the memory 50 to the digital signal processor 40. The correcting condition, thus produced, may preferably be stored until the one-push manual white balance button 64 is successively depressed.

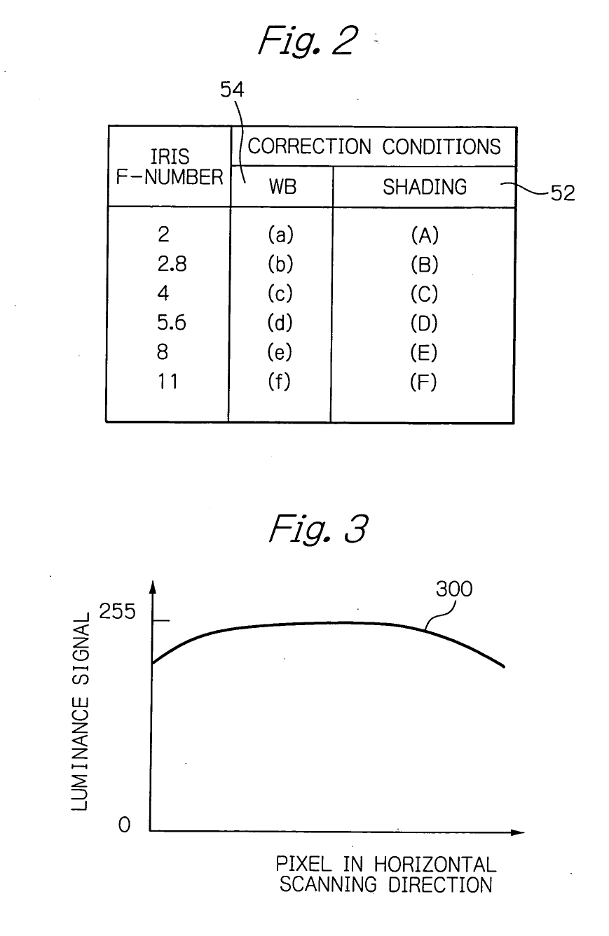

In manually adjusting the white balance, the controller 26 in the present embodiment produces the shading correction condition 52 and the white balance adjustment condition 54 for the respective stop numbers of the image pick-up lens 12, and stores the so-produced condition data in the memory 50. FIG. 2 shows an illustrative correction table, comprising white balance adjustment conditions (a) to (f) and shading correction conditions (A) to (F), corresponding with F-numbers (for example, F=2.0 to 11) of the iris stop 18, particularly affecting the shading.

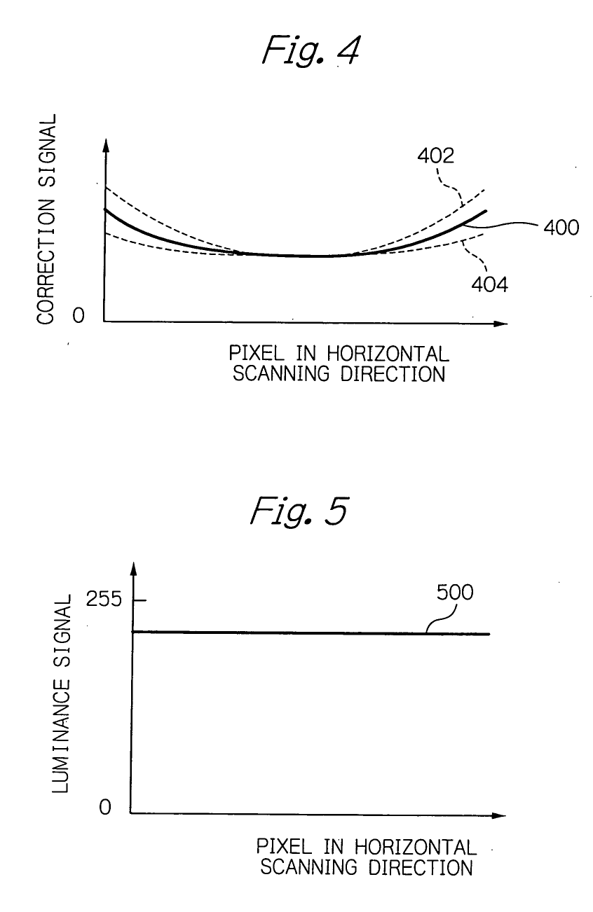

If a luminance signal 300 as shown in FIG. 3, for example, is obtained for the photosensitive cells in the horizontal scanning direction in the condition-finding image pickup operation carried out for manual white balance adjustment, then the controller 26 produces the shading correcting condition, represented by a shading correction signal 400, FIG. 4, which cancels out the variation of the luminance signal 300 caused by shading, from one horizontal scanning line to another. The curve for the shading correction condition 52 undergoes changed with the horizontal scanning line, as indicated by dotted lines 402 and 404, and the shading correction condition 52 represented by the correction signal is stored in the memory 50. In the present embodiment, the controller 26 formulates the shading correction condition for plural stop numbers to prepare for use with a specific stop number which will actually be used.

The shading correction condition 52, thus produced, is applied to the luminance signal 300, FIG. 3, and processed with summing operation in a shading corrector 42 of the digital signal processor 40. By doing so, a calculated output of luminance signal 500 having a constant luminance signal level is obtained for each of the photosensitive cells in the horizontal scanning direction, from one horizontal scanning line to another, thus correcting the luminance shading.

During manual white balance adjustment, the controller 26 reads out, from the memory 50, the values 98 of the white balance adjustment and shading correction conditions, associated with stop value set for actual imaging, and sends out the thus read out condition values 80 to the digital signal processor 40. The stop value is recognized when the controller 26 controls the iris driver 22. In a similar manner, the focal and zooming positions of the image pick-up lens 12 are controlled and recognized by the controller 26. When the image pick-up lens 12 is an interchangeable lens, the lens information, such as a zoom position, a focal position or a stop value, is preferably entered from the unit of the image pick-up lens 12 to the controller 26 for convenience during the manual operation.

The controller 26 formulates the white balance adjustment condition 54 for adjusting the white balance of the image for photographing, based on the image signal obtained with the condition-finding image pickup operation during the above-described manual white balance adjustment, and causes the resulting condition data to be stored in the memory 50. The controller 26 formulates the white balance adjustment condition 54 for plural stop numbers and causes the resultant condition data to be stored in the memory 50 in readiness for the stop value set on the occasion of actual imaging.

In the present embodiment, the R and B components of image data in a predetermined region of the photosensitive array generated from the image signal obtained in the condition-finding imaging are exploited to formulate the white balance adjustment condition 54 represented by the correction signal which causes the data of the R, G and B components to provide for the same level. The controller 26 formulates the white balance adjustment condition 54, in the same way as with the shading correction condition 52, for the respective horizontal scanning lines or every predetermined horizontal scanning line. In the actual imaging, the controller 26 causes the white balance adjustment condition 54, associated with the stop value used, to be read out from the memory 50 to correct the level of the respective color components in accordance with the white balance adjustment condition 54 in order to adjust the color balance.

Additionally, the controller 26 has the function of measuring the luminance level of an object field based on a photographed image represented by image signal data supplied thereto from the digital signal processor 40. Specifically, the controller 26 splits the image frame for photographing into eight subregions in the horizontal and vertical directions to form 64 image blocks in total to measure the block-based luminance level to estimate the photometric data needed for actual imaging. Based on the result of the luminance measurement, the controller 26 determines a light exposure value required at the time of photographing movie and still pictures to obtain the stop value and the exposure time (shutter speed). Moreover, in executing the condition-finding imaging, the controller 26 causes plural frames to be imaged, with the opening value of the iris stop 18 changed, while controlling the imaging of the plural frames with the shutter speed shifted in an operatively linked relationship to establish a constant amount of light exposure.

The digital signal processor 40 stores and operates image signal data 90 output from the A/D converter 32, under the control of the controller 26, to produce image data 92 for display on the display unit 46, as well as image data 94 for recording to the image data recorder 48. In particular, the digital signal processor 40 of the present embodiment includes the shading corrector 42 responsible for correcting the shading, and a white balance adjustment unit 44 for adjusting the white balance of the image signal data corrected in shading.

The digital signal processor 40 also includes a gamma corrector, a YC converter, an image size reducing circuit and a compander, all not specifically shown. The gamma corrector is adapted to convert the gamma or gradation of the image signal data, corrected and adjusted for shading and white balance, in accordance with a lookup table for gradation correction.

The shading corrector 42 is adapted to correct the image signal data, from pixel to pixel, based on the shading correction condition carried on the control signal 80 supplied from the controller 26. The white balance adjustment unit 44 is adapted to adjust the shading-corrected image signal data, from pixel to pixel, based on the white balance-adjustment condition 80 supplied from the controller 26.

The memory 50 includes a storage area for temporarily storing the data thus received and processed for further processing and developing. The signal processing such as shading correction is carried out by the digital signal processor 40 using the storage area as a working area. The memory 50 is responsive to control of the controller 26 so that image signal data are written in and read out.

The processor 40 includes a synchronizing circuit, not shown, which performs, in e.g. the still picture mode, pixel and color interpolation on the image data converted in gradation by the gamma corrector to calculate pixel values of the R, G and B components in the respective pixel positions. The synchronizing circuit further includes the function of generating virtual pixels, virtually arranged between the neighboring pixels, by pixel interpolation.

The YC converter, also not shown, includes the function of color matrix processing for calculating R, G and B pixel data from the image data 94 of the three prime color components stored in the image memory 50 to produce luminance data Y and color difference data Cr and Cb, of correcting the color difference data Cr and Cb with gain adjustment or the like, and of enhancing a contour or edge portion of the luminance data.

The compander, not shown, has the function of compressing and encoding the image data supplied in the still picture and movie modes, in accordance with an existing standard, such as JPEG (Joint Photographic coding Experts Group) or MPEG (Moving Picture coding Experts Group)-1 or -2. The compander outputs the compressed image data 94 to the image data recorder 48 under the control of the controller 26. The compander may also output the image data without compression, that is, as RAW data. The compander has the function of reading out and expanding the image data, recorded by the image data recorder 48, under the control of the controller 26.

The image size reducing unit, not shown, has the function of decimating or thinning the pixels of image data to thereby reduce the size of an image field represented by the image data, so as to adjust the image data to a picture size matching with the screen of the liquid crystal display accommodated in the display unit 46 or a display device connected to the display unit 46. The image size reducing unit outputs the processed image data 92 to the display unit 46.

Meanwhile, in the movie mode, the processing in the shading corrector 42 may be stopped, and carry out the processing in the white balance adjustment unit 44 and the gamma converter, and thereafter generate pixels in the synchronizing circuit.

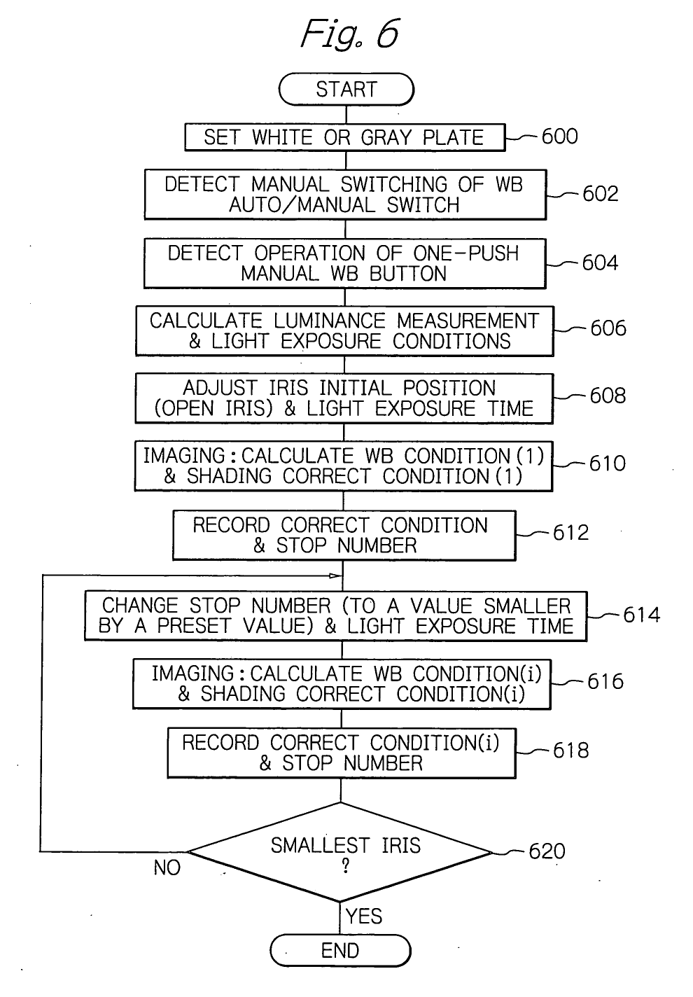

Referring now to FIG. 6, the operation of manual adjustment of the white balance in the digital camera 10 will be described. For manual white balance adjustment, the photographer places a white or gray board ahead of the image pick-up lens 12 (step 600). The photographer sets the white balance auto/manual switch 62 of the operating unit 60 to its manual side. The operation information representing the manipulation of the switch 62, detected by the operating unit 60, is in turn notified to the controller 26. The controller 26 then proceeds to a step 604. Upon receiving the operating information the controller 26 recognizes the user's manipulation of the one-push manual white balance button 64. The controller 26 then proceeds to a step 606 where the camera 10 images the board arranged in the object field. Based on the image signal, the luminance level of the object field is measured to estimate the condition for light exposure as a light exposure value.

In the next step 608, the controller 26 controls the iris stop 18 to its open state, the initial position. The controller 26 adjusts the light exposure time or shutter speed, which is to be the estimated light exposure value, by controlling the shutter driver 24 and the image sensor driver 28. In the next step 610, the controller 26 controls the imaging of one frame of the object field.

In the step 610, the shading correction condition [1] and the white balance correcting condition [1] are calculated by the controller 26, based on the image signal data obtained on photographing with the light exposure value. The correction conditions [1] and the stop number at the time of the condition-finding or calibration imaging (the opening value in this example) are output from the controller 26 to the memory 50 for recording.

Meanwhile, the camera 10 may be set, in finding out the white balance adjustment condition, so that the photographer is able to select in advance whether or not the shading correction condition is to be calculated simultaneously to allow the shading correction condition to be selected singly.

The controller 26 will now proceed to a step 614, where the iris stop 18 is controlled to a value smaller by one step, as a predetermined stop number, while the light exposure time is set to a value one step longer, in order to provide for the same light exposure. Under this condition, the next condition-finding imaging is carried out in a step 616. In the step 616, as in the step 610, the i-th (here, the second) shading correcting condition [i] and the i-th white balance correcting condition [i] are calculated, and the so-calculated correction conditions [i] and the stop number of the current condition-finding imaging are in turn stored in the memory 50 (618).

The controller 26 then proceeds to a step 620 where it is checked whether or not the stop number set in the steps 614 to 618 is the smallest light stop, that is the maximum F-number. If the result is “NO”, namely the stop number is not the smallest one, then the controller 26 reverts to the step 614 from which the above-described operation will be repeated. Conversely, if the result is ‘YES’, i.e. the current stop number is smallest, then the correction condition production in this calibration imaging comes to close. The white or gray plate, placed ahead of the image pick-up lens 12, is removed therefrom.

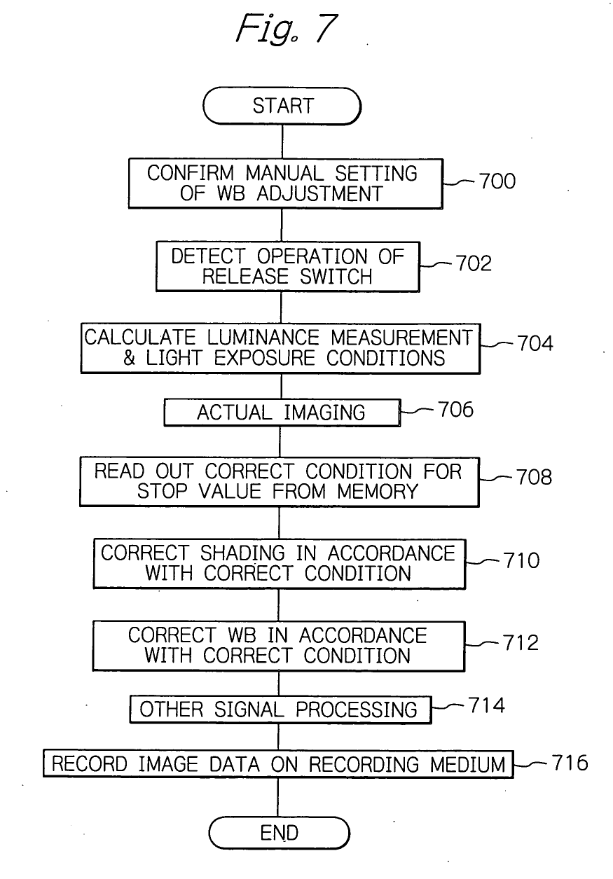

In this manner, the shading correction condition 52 and the white balance adjustment condition 54 are formulated and stored in the memory 50, while the imaging condition of the light stop is changed stepwise with the same light exposure volume. In this state, the actual imaging of an object desired by the photographer is carried out. This operation is now described with reference to FIG. 7.

The controller 26 confirms that the white balance auto/manual switch 62 is set to its manual side (step 700). The shading correction condition 52 and the white balance adjustment condition 54 formulated are saved in the memory 50. If the operating information, indicating the user's operation on the release switch, is detected by the operating unit 60 (step 702) then the controller 26 proceeds to a step 704, where the camera 10 images a desired object. Based on the image signal, the luminance level of the object field is detected by 64-subregion luminance measurement or photometry, and the light exposure condition (light exposure value) is determined by the controller 26 in accordance with the evaluation value calculated from the photometric value of the subregions. In this case, the stop number and the light exposure time are determined responsive to the operating information and to the light exposure mode, such as the iris-controlling mode or the shutter-controlling mode or the programmed mode. The actual imaging in a step 706 is carried out in accordance with the thus determined light exposure condition.

In the actual imaging of the step 706, the controller 26 controls the focusing of the image pick-up lens 12, then sets the still picture mode in the components of the camera 10 and transiently closes the mechanical shutter 20, while controlling the iris stop 18 to the thus determined stop number and driving the imaging device 14. The controller 26 then releases the mechanical shutter 20. The high-speed sweep-out of electrical charges is performed by the electronic shutter control for the imaging device 14, and the completion of the sweep-out causes the light exposure time to start. The light exposure time ends with the closure of the mechanical shutter 20. The image of the object field, captured by the imaging device 14, is photo-electrically transduced such that the image signal 84 corresponding to signal charges generated by the photosensitive cells are dot-sequentially output to the analog processor 30. The analog processor 30 performs the correlated-double sampling and variable-gain amplification. The processed image signal 88 is converted by the A/D converter 32 into a corresponding 12-bit digital value 90. The converted image signal data 90 are entered to the digital signal processor 40.

At this time, the digital signal processor 40 is supplied from the controller 26 with the shading correction condition 52 and the white balance adjustment condition 54, associated with the stop number used in the actual imaging, such that the image signal data are level-corrected by the shading corrector 42 in the pixel positions of each horizontal scanning line in accordance with the shading correction condition 52. The level-corrected image signal data are further adjusted by the white balance adjustment unit 44 as to the signal level of the R and B color components in accordance with the white balance adjustment condition 54. The level correction and adjustment are carried out on the image signal data which are temporarily stored in the memory 50.

After the signal processing, described above, the image signal data are gamma-corrected and processed for pixel generation. The so processed data is further converted to YC data, which is then subjected to gain processing. In recording the YC data, the YC data are subjected to compression encoding and the processed encoding data are supplied to the image data recorder 48 for recording in a preset information recording medium.

With the digital camera 10, described above, the conditions for white balance adjustment and shading correction are formed under an actual imaging condition and stored, when performing white balance adjustment by the manual operation. In performing white balance adjustment on the image signal 84 obtained by actual imaging, shading correction is performed under the shading correction condition thus formed, while white balance adjustment may automatically be performed under the white balance adjustment condition. Hence, double operating labor may be avoided while a high-quality photographed image may be produced. In this case, the respective corrections may be made accurately and delicately under the correction condition associated with the stop number used in the actual imaging. Even when the stop number is changed at the time of actual imaging, the laborious operation of re-formulating the correcting condition may be eliminated to provide for more flexible accommodation.

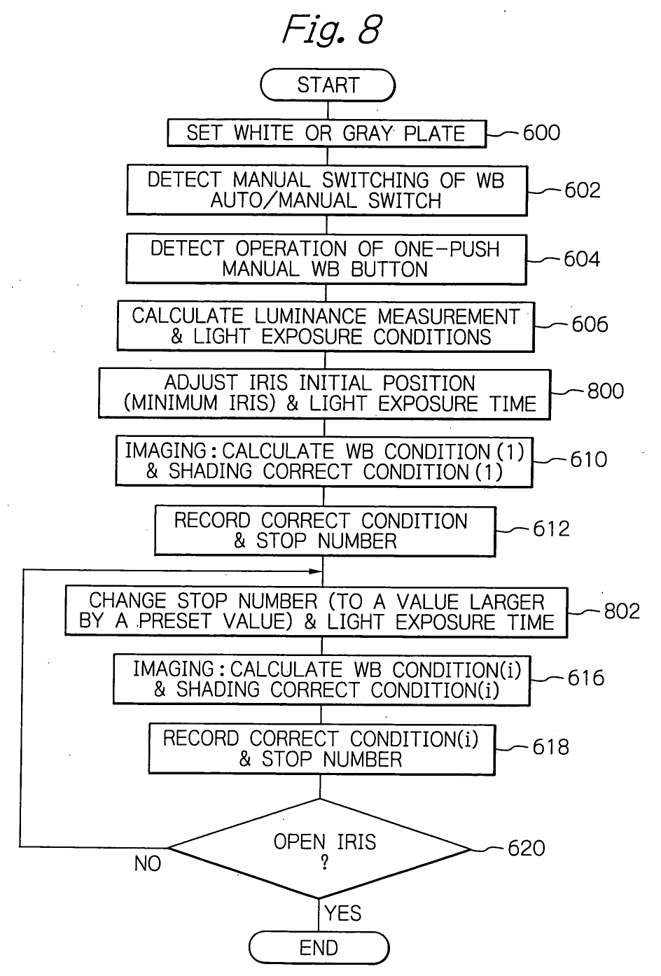

In the step 608, described with reference to FIG. 6, the initial iris stop position is the open state and the iris stop 18 is sequentially reduced in opening value for calculating the correction conditions 52 and 54 in the stop number of the respective stages. The present invention is, however, not limited to this specific example, such that it is also possible to calculate the correction condition with the iris stop sequentially enlarged in opening value in the opposite order, that is, from its smallest to full-open state, as shown in FIG. 8, in which the process steps which are the same as those of FIG. 6 are depicted by the same reference step numbers.

More specifically, in a step 800, following the step 606 in FIG. 8, the controller 26 controls the shutter driver 24 and the image sensor driver 28 to adjust the iris stop 18 to its smallest iris state, as its initial position, while adjusting the light exposure time (shutter time), as the calculated exposure value. In the following step 610, one frame of image is captured, and the correction condition is produced in the same step 610 and stored in the memory (step 620). The controller 26 then proceeds to a step 802. In the step 802, the iris stop 18 is controlled to a value one step larger, while the light exposure time is adjusted to a value one step shorter for providing the same volume of light exposure. The following steps 616 to 618 are repetitively executed in this manner. In a step 804, if the iris stop 18 is fully open, the processing for generating the correction condition comes to close.

In the case the stop value presumed to be used in the actual imaging has already been set definitely, the stop number is limited within a certain range, or the light exposure time to be used is limited, it is preferred to produce the correction condition with the corresponding range of iris stop opening value, thus reducing the volume of processing for producing the correction condition.

Moreover, in the case the image pick-up lens 12 or the iris stop 18 is of an interchangeable lens type that may be detachably mounted on the main body of the camera 10, it is preferable that, upon recognition of a lens mounting on the main body, the controller 26 causes the display unit 46 to demonstrate such a message reading as “adjust white balance manually” on the display screen of a liquid crystal monitor.

The entire disclosure of the Japanese patent application No. 2003-116900 filed on Apr. 22, 2003, including the specification, claims, accompanying drawings and abstract of the disclosure is incorporated herein by reference in its entirety.

While the present invention has been described with reference to the particular illustrative embodiments, it is not to be restricted to the embodiments. It is to be appreciated that those skilled in the art can change or modify the embodiment without departing from the scope and spirit of the present invention.

What is claimed is:

1. A digital camera for photo-electrically transducing an image of an object field formed by an image pick-up lens into an image signal representing the object field, comprising:
an image sensor for generating an image signal representing the image of the object field formed;
a signal processor for processing the image signal to produce image data;
an output circuit for outputting the image data produced;
a controller responsive to operating information for controlling said image sensor, said signal processor and said output circuit for generating a shading correction condition and a white balance adjustment condition for correcting the image signal;
a storage for storing the adjustment and correction conditions; and
an operating unit for receiving the operating information corresponding to an operation by an operator;
said controller producing, upon recognition that the operating information commands manual white balance adjustment controlling calibration imaging for imaging an object placed in front of the image pick-up lens, generating the shading correction condition and the white balance adjustment condition for correcting the image signal to be generated at a time of actual imaging, based on the image signal generated by said image sensor at a time of the calibration imaging, and causing the produced correction conditions to be stored in said storage;
said controller reading out, when commanding the actual imaging to cause the generated image signal to be processed by said signal processor, the shading correction condition and the white balance adjustment condition stored in said storage to send out the read-out correction conditions to said signal processor;
said signal processor correcting shading of the image signal for the actual imaging, in accordance with the shading condition supplied from said controller, and also correcting white balance of the image signal for the actual imaging, in accordance with the white balance adjustment condition supplied from said controller.

2. The digital camera according to claim 1, wherein, in the calibration imaging, said controller produces the shading correction condition associated with a plurality of stop numbers to cause the produced correction condition to be stored in said storage.

3. The digital camera according to claim 2, wherein said controller reads out the shading correction condition, associated with the stop number used in the actual imaging, from said storage, to send out the read-out correction condition to said signal processor.

4. The digital camera according to claim 1, wherein said controller in the calibration imaging produces the white balance adjustment condition associated with a plurality of stop numbers to cause the produced correction condition to be stored in said storage.

5. The digital camera according to claim 4, wherein said controller reads out the white balance adjustment condition, associated with the stop number used at the time of the actual imaging, from said storage, to send out the read-out correction condition to said signal processor.

6. A method of controlling imaging with an image sensor photo-electrically transducing an optical image formed on the image sensor through an imaging lens to generate an image signal, comprising:
a step of recognizing operating information commanding manual white balance adjustment;
a calibration imaging step of imaging an object for use in calibrating the manual white balance adjustment;
a correction condition generating step of generating a shading correction condition for correcting shading of an image signal generated in actual imaging, and a white balance adjustment condition for adjusting white balance of the image signal generated in the actual imaging, based on the image signal generated by said calibration imaging step;
an actual imaging step of controlling the actual imaging responsive to operating information corresponding to an operation by an operator; and
a signal processing step of processing the image signal generated by said actual imaging step, and correcting the shading of the image signal generated by said actual imaging step, based on the shading correction condition and the white balance adjustment condition.

7. The method according to claim 6, wherein said calibration imaging step produces the shading correction condition associated with a plurality of stop numbers.

8. The method according to claim 7, wherein said signal processing step corrects the image signal based on the shading correction condition associated with one of the stop numbers which was used in said actual imaging step.

9. The method according to claim 6, wherein said calibration imaging step produces the white balance adjustment condition associated with a plurality of stop numbers.

10. The method according to claim 9, wherein said signal processing step corrects the image signal based on the white balance adjustment condition associated with one of the stop numbers which was used in said actual imaging step.
